(19) United States
(12) Patent Application Publication
(10) Pub. No.: US 2024/0332543 A1
(43) Pub. Date: Oct. 3, 2024

(54) BATTERY

(71) Applicant: TOYOTA JIDOSHA KABUSHIKI KAISHA, Toyota-shi (JP)

(72) Inventor: Yuya TAKAHASHI, Mishima-shi (JP)

(73) Assignee: TOYOTA JIDOSHA KABUSHIKI KAISHA, Toyota-shi (JP)

(21) Appl. No.: 18/410,180

(22) Filed: Jan. 11, 2024

(30) Foreign Application Priority Data
Mar. 30, 2023 (JP) 2023-055098

(51) Int. Cl. H01M 4/70; H01M 50/186; H01M 50/474; H01M 50/477

(52) U.S. Cl. CPC H01M 4/70; H01M 50/186; H01M 50/474; H01M 50/477

(57) ABSTRACT

The battery includes a laminate including a battery cell and intermediate members disposed on both sides of the battery cell in the thickness direction. The battery cell includes an electrode lamination portion in which a plurality of electrodes is laminated in the thickness direction, and a seal portion disposed covering an outer edge of the electrode lamination portion. The intermediate members include a current collector plate portion and an elastic body portion. When the battery is viewed in plan from the thickness direction, the area of the current collector plate portion is smaller than the area of the battery cell, the current collector plate portion has a notch, and the elastic body portion is disposed in the notch, and the elastic body portion overlaps with the seal portion.

### CROSS-REFERENCE TO RELATED APPLICATION

This application claims priority to Japanese Patent Application No. 2023-055098 filed on Mar. 30, 2023, incorporated herein by reference in its entirety.

### BACKGROUND

### 1. Technical Field

The present disclosure relates to a battery.

### 2. Description of Related Art

A battery normally includes a laminate including a negative electrode current collector, a negative electrode active material layer, a separator layer, a positive electrode active material layer, and a positive electrode current collector.

For example, Japanese Patent No. 6,826,916 discloses a battery pack that includes a single cell, and a seal portion that seals an outer periphery portion of the single cell. The single cell is made by laminating a positive electrode current collector layer, a positive electrode layer (positive electrode active material layer), a separator, a negative electrode layer (negative electrode active material layer), and a negative electrode current collector layer, in that order. Also, Japanese Unexamined Patent Application Publication No. 2003-317795 (JP 2003-317795 A) discloses a battery that has a pressure absorbing structure. In the pressure absorbing structure, out of part or all of battery components, at least one of current collectors, a battery cell, and a separator, is a pressure absorbing member that has a property of absorbing pressure.

### SUMMARY

In a battery, it is assumed that a battery cell having an electrode lamination portion and a seal portion is used. In the electrode lamination portion, a plurality of electrodes is laminated in a thickness direction. The seal portion is disposed at an outer edge of the electrode lamination portion. Also, it is assumed that current collector plates are disposed on both sides of the battery cell in the thickness direction, in order to collect electricity from the battery cell. Now, the electrode lamination portion may come to bulge, depending on a state of charging/discharging of the battery, and change over time. This may cause a difference between thickness of the electrode lamination portion and thickness of the seal portion. When there is a difference between the thickness of the electrode lamination portion and the thickness of the seal portion, the current collector plates may be damaged, which will be described in detail later. The outer edge of the electrode lamination portion that is sealed by the seal portion may be damaged. Accordingly, there is room for improving structural reliability of the battery.

The present disclosure has been made in view of the above circumstances, and a main purpose thereof is to provide a battery with good structural reliability.

(1)

An aspect of the present disclosure relates to a battery including a laminate, the battery including a battery cell, and intermediate members disposed on each of both faces of the battery cell in a thickness direction. The battery cell includes an electrode lamination portion in which a plurality of electrodes is laminated in the thickness direction, and a seal portion disposed covering an outer edge of the electrode lamination portion. The intermediate members include a current collector plate portion and an elastic body portion. In plan view of the battery from the thickness direction, an area of the current collector plate portion is smaller than an area of the battery cell. In plan view of the battery from the thickness direction, the current collector plate portion includes a notched portion. In plan view of the battery from the thickness direction, the elastic body portion is disposed in the notched portion. In plan view of the battery from the thickness direction, the elastic body portion overlaps the seal portion.

(2)

An aspect of the disclosure relates to a battery including a laminate, the battery including a battery cell, and intermediate members disposed on each of both faces of the battery cell in a thickness direction. The battery cell includes an electrode lamination portion in which a plurality of electrodes is laminated in the thickness direction, and a seal portion disposed covering an outer edge of the electrode lamination portion. The intermediate members include a current collector plate portion and an elastic body portion. In plan view of the battery from the thickness direction, an area of the current collector plate portion is smaller than an area of the battery cell. In plan view of the battery from the thickness direction, the elastic body portion is disposed outside of an outer edge of the current collector plate portion. In plan view of the battery from the thickness direction, the elastic body portion overlaps the seal portion.

(3)

In the battery according to (2), the elastic body portion is disposed outside an entire periphery of the outer edge of the current collector plate portion.

(4)

In the battery according to any one of (1) to (3), with an intermediate member located at a first end of the battery that is a lower side in a gravitational direction, as a first intermediate member, and an intermediate member located at a second end of the battery that is an upper side in the gravitational direction, as a second intermediate member, rigidity of the elastic body portion in the first intermediate member is greater than rigidity of the elastic body portion in the second intermediate member.

(5)

In the battery according to any one of (1) to (4), the battery includes a plurality of the laminates stacked in the thickness direction.

The present disclosure has the advantage of being able to provide a battery with good structural reliability.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a schematic cross-sectional view illustrating a battery in the present disclosure;

FIG. 2A is a schematic cross-sectional view illustrating the reason why a problem occurs in the present disclosure and the mechanism by which the problem can be solved;

FIG. 2B is a schematic cross-sectional view illustrating the reason why a problem occurs in the present disclosure and the mechanism by which the problem can be solved;

FIG. 2C is a schematic cross-sectional view illustrating the reason why a problem occurs in the present disclosure and the mechanism by which the problem can be solved;

FIG. 2D is a schematic cross-sectional view illustrating the reason why a problem occurs in the present disclosure and the mechanism by which the problem can be solved;

FIG. 3A is a schematic plan view illustrating a battery cell in the present disclosure;

FIG. 3B is a schematic cross-sectional view illustrating a battery cell in the present disclosure;

FIG. 4A is a schematic plan view illustrating an intermediate member in the present disclosure;

FIG. 4B is a schematic plan view illustrating an intermediate member in the present disclosure;

FIG. 4C is a schematic plan view illustrating an intermediate member in the present disclosure;

FIG. 4D is a schematic plan view illustrating an intermediate member in the present disclosure;

FIG. 5A is a schematic plan view illustrating an intermediate member in the present disclosure; and

FIG. 5B is a schematic plan view illustrating the intermediate member in the present disclosure.

### DETAILED DESCRIPTION OF EMBODIMENTS

Hereinafter, embodiments of the present disclosure will be described in detail using the drawings. Each figure shown below is shown schematically. The size and shape of each part are appropriately exaggerated to facilitate understanding. In addition, in this specification, when expressing a mode of arranging another member with respect to a certain member, when it is simply expressed as “above” or “below,” unless otherwise specified, the following (1), including cases (2).
(1) When placing another member directly above or below a certain member so that it is in contact with it
(2) When placing another member above or below a certain member via another member

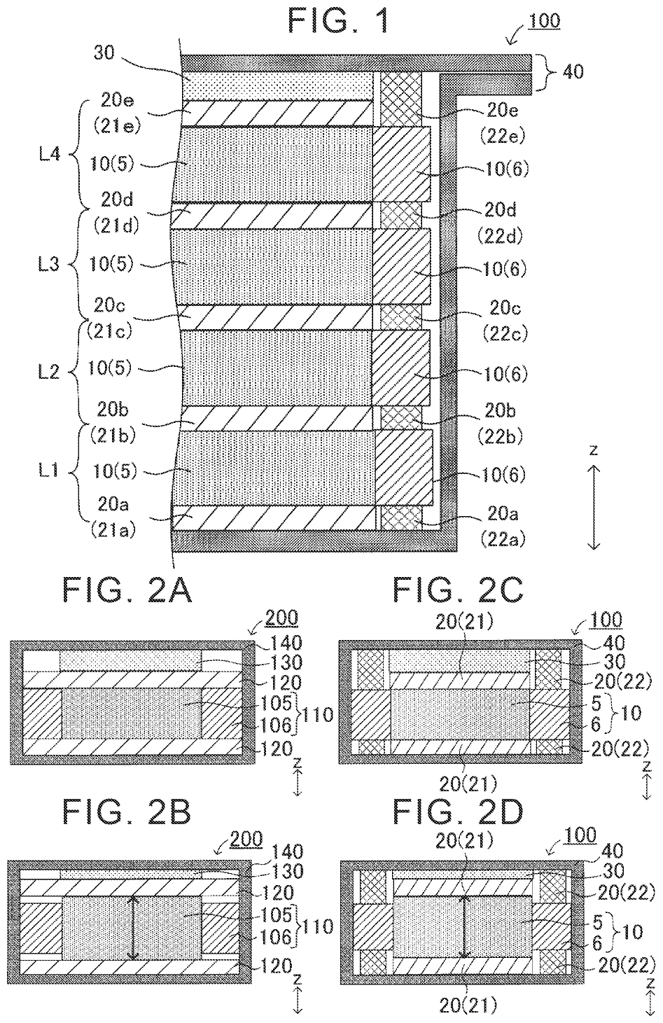

FIG. 1 is a schematic cross-sectional view illustrating a battery according to the present disclosure. The battery 100 shown in FIG. 1 includes a laminate L (L1 to L4) that includes a battery cell 10 and an intermediate member 20. The intermediate members 20 are arranged on both sides of the battery cell 10 in the thickness direction z. As will be described in detail later, the battery cell 10 includes an electrode lamination portion 5 and a seal portion 6. In the electrode lamination portion 5, a plurality of electrodes is laminated in the thickness direction z. The seal portion 6 is arranged at the outer edge of the electrode lamination portion 5. Further, the intermediate member 20 includes a current collector plate portion 21 and an elastic body portion 22. Furthermore, when the battery 100 is viewed from above in the thickness direction z, the area of the current collector plate portion 21 is smaller than the area of the battery cell 10. Further, the elastic body portion 22 overlaps with the seal portion 6. Although details will be described later, in the intermediate member, the current collector plate portion may have a notched portion. The elastic body portion may be arranged in the notched portion. Further, in the intermediate member, the elastic body portion may be disposed outside an outer edge of the current collector plate portion.

According to the present disclosure, predetermined intermediate members are arranged on both sides of the battery cell in the thickness direction, and the elastic body portion of the intermediate member overlaps with the seal portion of the battery cell. Therefore, the structural reliability of the battery is good.

The reason why a problem occurs in the present disclosure and the mechanism by which the problem can be solved will be explained using FIGS. 2A to 2D. FIGS. 2A and 2B are diagrams explaining why problems occur in the present disclosure. FIGS. 2C and 2D are diagrams illustrating a mechanism by which the problem can be solved in the present disclosure.

The battery 200 shown in FIG. 2A includes a battery cell 110 and an intermediate member (current collector plate) 120. The battery cell 110 has an electrode lamination portion 105 and a seal portion 106. The intermediate member (current collector plate) 120 is arranged on both sides of the battery cell 110 in the thickness direction z. Further, in the battery 200, a buffer member 130 is arranged at one end in the thickness direction z to absorb expansion of the battery cell. Further, these members are housed in an exterior body 140. In such a battery, as shown in FIG. 2B, the positive electrode active material layer and the negative electrode active material layer in the electrode lamination portion expand due to charging/discharging conditions and changes over time, and the electrode lamination portion may also expand. Basically, the seal portion that seals the end of the electrode lamination portion does not expand, or the amount of expansion is extremely small. Therefore, there may be a difference in thickness between the electrode lamination portion and the seal portion. In that case, a gap may occur between the current collector plate and the seal portion. If vibration is applied to the battery in the thickness direction while such a gap exists, the seal portion may vibrate on its own. If the seal portion vibrates independently, the seal portion and the current collector plate may come into contact and the current collector plate may be damaged. Furthermore, the outer edge of the electrode lamination portion sealed by the seal portion may be damaged. Although not particularly shown in the drawings, in the electrode lamination portion, the expansion of the active material layers (positive electrode active material layer and negative electrode active material layer) causes the thickness of the active material layer and the thickness of the seal portion that seals the ends of the active material layer to increase. There may be a difference. In that case as well, the seal portion may vibrate independently. Additionally, the current collector in the electrode lamination portion may be damaged.

On the other hand, as shown in FIG. 2C, in the present disclosure, the intermediate member 20 includes a current collector plate portion 21 and an elastic body portion 22. The intermediate members 20 are arranged on both sides of the battery cell 10, respectively. The area of the current collector plate portion 21 is smaller than the area of the battery cell 10. The elastic body portion 22 is arranged at a predetermined position on the current collector plate portion 21. Further, the elastic body portion 22 overlaps the seal portion 6 in the thickness direction z. In such a battery, when the electrode lamination portion 5 expands and there is a difference in thickness from the seal portion 6, the compressive force (load) applied to the elastic body portion 22 decreases, and the elastic body portion 22 Deforms to return to its unloaded length (free length). Therefore, as shown in FIG. 2D, the clastic body portion 22 can support the seal portion 6. Therefore, generation of gaps can be suppressed. As a result, it is possible to suppress the seal portion from independently vibrating, thereby improving the structural reliability of the battery. In addition, by increasing the thickness of the intermediate member (current collector plate 120) in the battery 200 shown in FIGS. 2A and 2B, the durability of the current collector plate can be improved and damage to the current collector plate can be suppressed. it is conceivable that. However, it is difficult to suppress damage to the outer edge of the electrode lamination portion sealed by the seal portion. Furthermore, if the current collector plate is made thicker, the electrical resistance will increase. The same applies to the current collector inside the electrode lamination portion. On the other hand, according to the present disclosure, damage to the current collector plate can be suppressed without increasing the thickness of the current collector plate. Therefore, there is an advantage that the structural reliability of the battery can be improved while avoiding an increase in electrical resistance.

### 1. Laminate

The laminate in the present disclosure includes a battery cell and an intermediate member.

### (1) Battery Cell

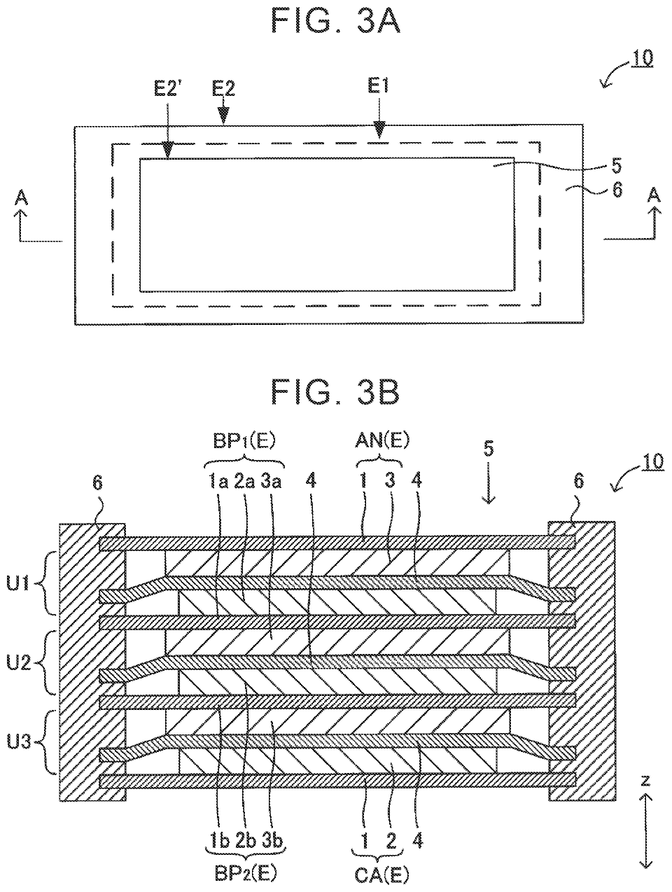

FIGS. 3A and 3B are a schematic plan view and a schematic cross-sectional view, respectively, illustrating a battery cell according to the present disclosure. FIG. 3A is a schematic plan view of a battery cell viewed from the thickness direction. FIG. 3B is a sectional view taken along line A-A in FIG. 3A.

As shown in FIGS. 3A and 3B, the battery cell 10 includes an electrode lamination portion 5 and a seal portion. In the electrode lamination portion 5, a plurality of electrodes E are laminated in the thickness direction z. The seal portion is arranged to cover the outer edge of the electrode lamination portion 5. As shown in FIG. 3A, the “outer edge of the electrode lamination portion” refers to the outer edge of the current collector that constitutes the electrode lamination portion. In FIG. 3A, the seal portion 6 is arranged so as to cover the outer edge E1 of the electrode lamination portion 5. The seal portion 6 has an outer edge E2 and an inner edge E2′. The outer edge E2 of the seal portion 6 is located outside the outer edge E1 of the electrode lamination portion 5. The inner edge E2′ of the seal portion 6 is located inside the outer edge E1 of the electrode lamination portion 5. Moreover, as shown in FIG. 3A, it is preferable that the seal portion 6 is arranged along the entire circumference of the outer edge E1 of the electrode lamination portion 5.

The electrode in the electrode lamination portion usually includes a current collector and an electrode layer disposed on at least one surface of the current collector. As shown in FIG. 3B, the electrode lamination portion 5 may have a bipolar electrode (BP) as the electrode E, which includes a current collector 1, a positive electrode active material layer 2, and a negative electrode active material layer 3. good. Positive electrode active material layer 2 is arranged on one surface of current collector 1. Negative electrode active material layer 3 is arranged on the other surface of current collector 1. Note that the electrode lamination portion in the present disclosure does not need to include bipolar electrodes. The electrode lamination portion 5 shown in FIG. 3B includes, as electrodes E, a bipolar electrode BP1, a bipolar electrode BP2, a positive electrode side end electrode CA, and a negative end electrode AN. The positive electrode side end electrode CA includes a current collector 1 and a positive electrode active material layer 2. Positive electrode active material layer 2 is arranged on one surface of current collector 1. The negative end electrode AN includes a current collector 1 and a negative electrode active material layer 3. Negative electrode active material layer 3 is arranged on one surface of current collector 1. The number of electrodes is not particularly limited, and is, for example, 10 or more and 50 or less.

Further, as shown in FIG. 3B, the electrode lamination portion 5 includes power generation units U (U1 to U3). The power generation unit U includes a positive electrode active material layer 2, a negative electrode active material layer 3, and a separator 4. Separator 4 is arranged between positive electrode active material layer 2 and negative electrode active material layer 3. Further, the electrode lamination portion in the present disclosure may have one power generation unit, or may have two or more power generation units.

One power generation unit may be configured using two bipolar electrodes. In FIG. 3B, the electrode lamination portion 5 has a bipolar electrode BP1 and a bipolar electrode BP2 in the thickness direction z. A separator 4 is arranged between adjacent bipolar electrode BP1 and bipolar electrode BP2. The power generation unit U2 includes a positive electrode active material layer 2b in the bipolar electrode BP2, a negative electrode active material layer 3a in the bipolar electrode BP1, and a separator 4 disposed between them. On the other hand, the power generation unit U1 includes a positive electrode active material layer 2a in the bipolar electrode BP1, a negative electrode active material layer 3 in the negative end electrode AN, and a separator 4 disposed between them. Moreover, the power generation unit U3 is comprised of the negative electrode active material layer 3b in the bipolar electrode BP2, the positive electrode active material layer 2 in the positive electrode side end electrode CA, and the separator 4 arranged between them.

The materials of the current collector, positive electrode active material layer, negative electrode active material layer, separator, and current collector in the electrode lamination portion can be conventionally known materials. Note that the positive electrode active material layer, the negative electrode active material layer, and the separator may contain an electrolyte. The electrolyte may be a liquid electrolyte (electrolytic solution) or a solid electrolyte. Here, when the separator contains a solid electrolyte, the separator can be regarded as a solid electrolyte layer. The electrolyte can also be made of conventionally known materials.

The material of the seal portion is not particularly limited, but examples include thermoplastic resin. Examples of the thermoplastic resin include olefin resins such as polyethylene and polypropylene, and polyester resins such as polyethylene terephthalate.

### (2) Intermediate Member

The intermediate member in the present disclosure is a member disposed on both surfaces of the battery cell in the thickness direction, and includes a predetermined current collector plate portion and an elastic body portion.

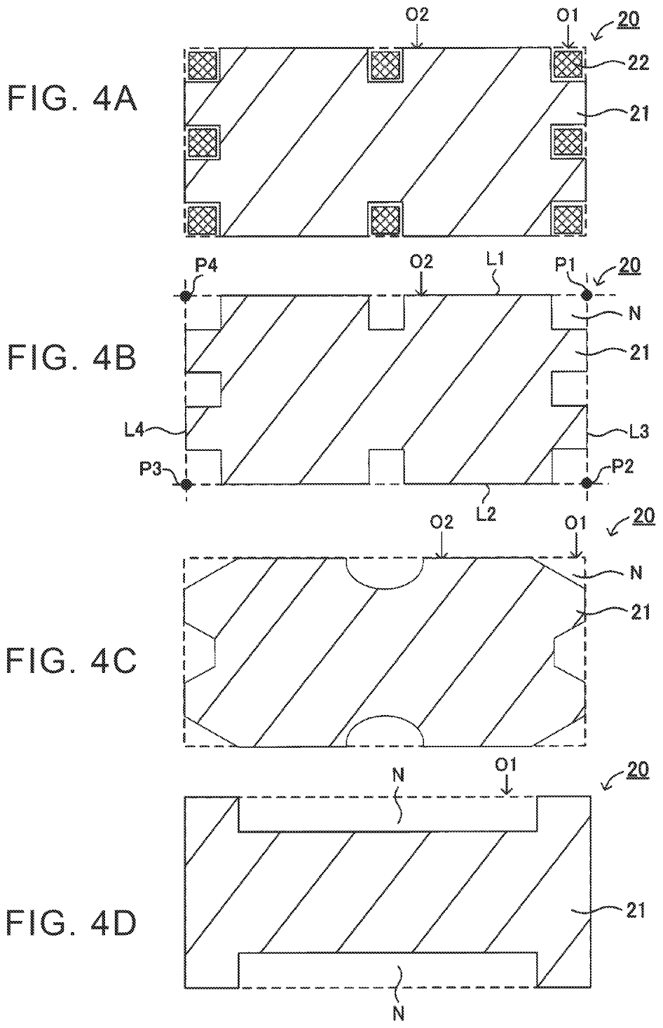

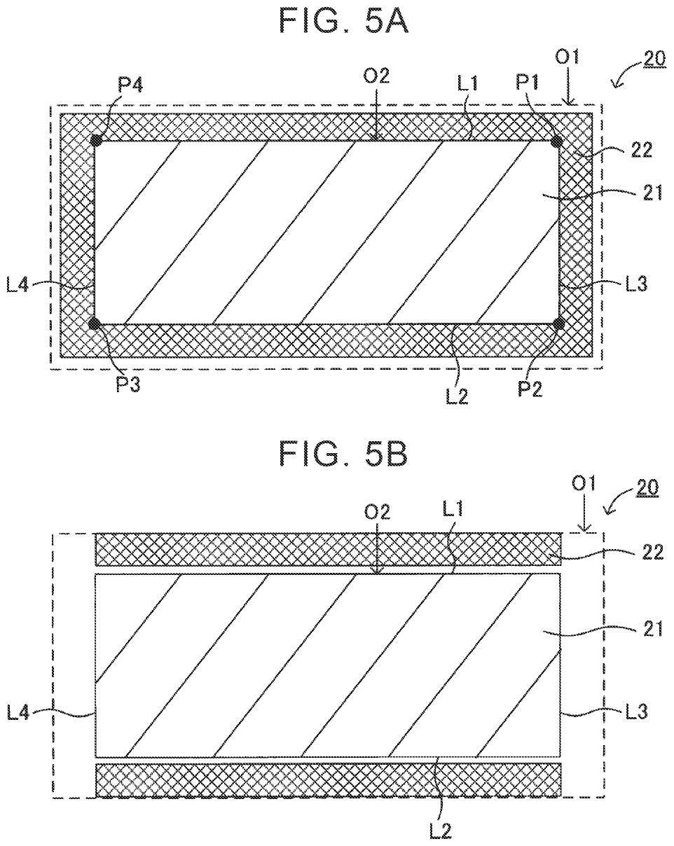

FIGS. 4A to 4D, 5A, and 5B are schematic plan view illustrating an intermediate member in the present disclosure. Specifically, FIGS. 4A to 4D illustrate an intermediate member in which an elastic body portion is disposed in a notched portion of a current collector plate portion. FIGS. 5A and 5B illustrate an intermediate member in which an elastic body portion is disposed outside the outer edge of the current collector plate portion. Note that FIG. 4B is a diagram in which the elastic body portion is omitted from FIG. 4A. Further, the clastic body portion is omitted in FIGS. 4C and 4D. In addition, in FIGS. 4A to 4D, 5A, and 5B, O1 indicates the outer edge of the battery cell (outer edge of the seal portion), and O2 indicates the outer edge of the current collector plate portion.

Here, as shown in FIGS. 4B and 5A, when the current collector plate portion 21 has sides L1 to L4, the outer edge of the current collector plate portion refers to the intersections P1 to P4 of the sides L1 to L4 and the sides L1 to L4. (FIG. 5A), or the outer edge (FIG. 4B) consisting of sides L1 to L4 and intersections P1 to P4 of extension lines of sides L1 to L4.

As shown in FIGS. 4A to 4D, in the intermediate member 20 according to the present disclosure, the current collector plate portion 21 may have a notched portion N. The elastic body portion 22 may be arranged in the notched portion N. The notched portion typically passes through the current collector plate portion in the thickness direction.

The shape of the notched portion is not particularly limited. As shown in FIGS. 4A to 4D, the shape of the notched portion may be rectangular such as a square, rectangle, or trapezoid, circular such as an ellipse, or triangular. Furthermore, when the current collector plate portion has a plurality of notched portions, the shapes of the notched portions may be the same or different.

The number and size of the notched portions are not particularly limited and can be adjusted as appropriate. In addition, it is preferable that the number of notched portions is two or more. This is because the load applied to the elastic body portion disposed in the notched portion can be dispersed. Further, the position where the notched portion is formed is not particularly limited, but as shown in FIG. 4D, it is preferable that the notched portion is formed at least on two opposing sides of the current collector plate portion. In particular, as shown in FIGS. 4A to 4C, it is preferable to form on all sides of the current collector plate portion. Further, as described later, the elastic body portion disposed in the notched portion overlaps the seal portion in the thickness direction. Therefore, as shown in FIGS. 4A to 4D, at least a portion of the notched portion usually exists inside the outer edge O1 of the battery cell.

Moreover, as shown in FIG. 4A, the clastic body portion 22 arranged in the notched portion N does not have to be in contact with the current collector plate portion 21. On the other hand, although not particularly illustrated, the elastic body portion may be in contact with the current collector plate portion. By having a gap between the clastic body portion and the current collector plate portion, when a load is applied to the intermediate member and the elastic body portion is compressed, a space can be secured for the elastic body portion to be expanded, and the current collector plate portion can be expanded. Damage can be suppressed.

Further, as shown in FIGS. 5A and 5B, in the intermediate member 20 according to the present disclosure, the clastic body portion 22 may be arranged outside the outer edge O2 of the current collector plate portion 21. In this case, as shown in FIG. 5A, the elastic body portion 22 may be arranged outside the entire circumference of the outer edge O2 of the current collector plate portion 21. As shown in FIG. 5B, it may be arranged outside a part of the outer edge O2 of the current collector plate portion 21.

When the elastic body portion 22 is arranged outside the outer edge O2 of the current collector plate portion 21, as shown in FIGS. 5A and 5B, the current collector plate portion does not need to have the above-mentioned notched portion. On the other hand, although not shown, in this case, the current collector plate portion may have a notched portion.

Further, the elastic body portion disposed outside the outer edge of the current collector plate portion may or may not be in contact with the current collector plate portion as described above.

Further, when the battery is viewed in plan from the thickness direction, the area of the current collector plate portion in the intermediate member is smaller than the area of the power generation cell. Note that the area of the current collector plate portion refers to the area of the current collector plate portion excluding the notched portion when the current collector plate portion has a notched portion.

Further, when the battery is viewed from above in the thickness direction, the elastic body portion overlaps the seal portion. A part of the region of the elastic body portion may overlap with the seal portion. All regions of the elastic body portion may overlap with the seal portion.

The thickness of the elastic body portion in the intermediate member is not particularly limited as long as it can come into contact with the seal portion of an adjacent battery cell.

The material of the current collector plate portion is not particularly limited, and examples thereof include metal materials such as Al, Cu, SUS, and Ni.

Further, the material of the elastic body portion is not particularly limited, and examples thereof include resin materials such as rubber, urethane, and resin sponge. Further, it is preferable that the Young's modulus of the elastic body portion is smaller than that of the seal portion. If the Young's modulus of the elastic body portion is too larger than the Young's modulus of the seal portion, the seal portion may be compressed more than the elastic body portion and the seal portion may be damaged. For example, when placing an intermediate member on a battery cell and applying compressive force in the thickness direction, that is, when pressing down the elastic body portion with the seal portion of the battery cell, the seal portion is compressed more than the elastic body portion, and the seal portion is compressed more than the elastic body portion. may be damaged.

Here, the intermediate member located at the first end of the battery, which is the lower side in the direction of gravity, is referred to as the first intermediate member, and the intermediate member located at the second end of the battery, which is the upper side in the direction of gravity, is referred to as the second intermediate member. In this case, the rigidity of the elastic body portion in the first intermediate member is preferably greater than the rigidity of the elastic body portion in the second intermediate member. Note that the clastic body portion of the first intermediate member is referred to as a first elastic body portion. The clastic body portion of the second intermediate member is referred to as a second elastic body portion. For example, in FIG. 1, intermediate member 20a is the first intermediate member. Intermediate member 20e is the second intermediate member. That is, in FIG. 1, the rigidity of the clastic body portion 22a is preferably greater than the rigidity of the elastic body portion 22e. This is because deflection can be suppressed. For example, at least the weight of the seal portion of the battery cell and the weight of the second elastic body portion are added to the first elastic body portion. Therefore, if the rigidity of the first clastic body portion is too smaller than the rigidity of the second elastic body portion, deflection may occur. In particular, if the battery comprises multiple laminates, as shown in FIG. 1, the deflection may be greater.

The rigidity of the elastic body portion can be calculated from the following formula. In the formula, K means the rigidity of the elastic body portion. E means Young's modulus of the elastic body portion. A means the cross-sectional area of the elastic body portion. L means the free length of the elastic body portion.

$$K = EA / L$$

Further, as shown in FIG. 1, when the battery includes a plurality of laminates (L1 to L4), that is, one or more elastic body portions (22b to 22d) are arranged between the first elastic body portion (22a) and the second elastic body portion (22e). In that case, among all the elastic body portions, if the first elastic body portion 22a has the highest rigidity and the second elastic body portion 22e has the lowest rigidity, the rigidity of the other elastic body portions (22b to 22d) is particularly limited. Not done. For example, the rigidity of the clastic body portions 22b to 22d may be the same as the rigidity of the first clastic body portion 22a. The rigidity may be the same as that of the second elastic body portion 22c. Alternatively, the rigidity may decrease in the order of the first elastic body portion 22a, the clastic body portions 22b, 22c, 22e, and the second clastic body portion 22c.

Here, the rigidities of the elastic body portions 22a to 22e in FIG. 1 are respectively K1 to K5. Furthermore, the weight of the seal portion in one laminate is M, and the weights of the elastic body portions 22a to 22e are m1 to m5, respectively. In this case, the rigidities K2 to K4 of the elastic body portions 22b to 22d may have the following relationships with respect to K1, respectively. As mentioned above, K5 may be the same as K4 or may be smaller than K4.

$$K 4 = [ ( M + m 5 ) / ( 4 M + m 1 + m 2 + m 3 + m 4 + m 5 ) ] K 1$$

$$K 3 = [ ( 2 M + m 5 + m 4 ) / ( 4 M + m 1 + m 2 + m 3 + m 4 + m 5 ) ] K 1$$

$$K 2 = [ ( 3 M + m 5 + m 4 + m 3 ) / ( 4 M + m 1 + m 2 + m 3 + m 4 + m 5 ) ] K 1$$

### (3) Laminate

In the laminate according to the present disclosure, an adhesive layer may be disposed between the battery cell and the intermediate member described above. It is preferable that the adhesive layer has electrical conductivity. Although the thickness of the adhesive layer can be adjusted as appropriate, it is preferably thin from the viewpoint of suppressing resistance.

The battery may include one laminate. On the other hand, the battery may include a plurality of laminates stacked in the thickness direction. In the latter case, the number of laminates may be 3 or more, or 4 or more. Furthermore, when there is a plurality of laminates, as shown in FIG. 1, adjacent laminates usually share an intermediate member.

### 2. Other Parts

As shown in FIG. 1, the battery according to the present disclosure may include a buffer member 30 at least one end in the thickness direction. The buffer member 30 is a member for absorbing impact applied in the thickness direction and expansion of the electrode lamination portion. Further, the battery according to the present disclosure may include an exterior body 40 that houses the above-mentioned members, as shown in FIG. 1.

### 3. Batteries and Battery Manufacturing Methods

Examples of the battery in the present disclosure include a lithium-ion secondary battery. Further, the battery may be an all-solid battery containing a solid electrolyte as an electrolyte. The battery may be a liquid battery containing a liquid electrolyte (electrolyte) as an electrolyte. Further, examples of uses for batteries include power sources for vehicles such as hybrid electric vehicles (HEV), plug-in hybrid electric vehicles (PHEV), battery electric vehicles (BEV), gasoline vehicles, and diesel vehicles. In particular, it is preferably used as a power source for driving a hybrid electric vehicle (HEV), plug-in hybrid electric vehicle (PHEV), or battery electric vehicle (BEV). Batteries may also be used as a power source for moving objects other than vehicles (for example, trains, ships, and airplanes), and may be used as a power source for electrical products such as information processing devices.

Furthermore, the present disclosure can also provide a method for manufacturing the battery described above. Specifically, the present disclosure provides a method for manufacturing a battery including a laminate including a battery cell and intermediate members disposed on both sides of the battery cell in the thickness direction. This method includes a preparation step of preparing the battery cell, and a placement step of arranging the intermediate member on both sides of the battery cell in the thickness direction to obtain the laminate. The battery cell includes an electrode lamination portion in which a plurality of electrodes is laminated in the thickness direction, and a seal portion disposed at an outer edge of the electrode lamination portion. The intermediate members include a current collector plate portion and an clastic body portion. When the laminate is viewed in plan from the thickness direction, the area of the current collector plate portion is smaller than the area of the battery cell. The current collector plate portion has a notched portion. The clastic body portion is arranged in the notched portion. The clastic body portion overlaps the seal portion.

Further, the present disclosure can also provide a method for manufacturing a battery including a laminate including a battery cell and intermediate members disposed on both sides of the battery cell in the thickness direction. This method includes a preparation step of preparing the battery cell, and a placement step of arranging the intermediate member on both sides of the battery cell in the thickness direction to obtain the laminate. The battery cell includes an electrode lamination portion in which a plurality of electrodes is laminated in the thickness direction, and a seal portion disposed at an outer edge of the electrode lamination portion. The intermediate members include a current collector plate portion and an elastic body portion. When the laminate is viewed in plan from the thickness direction, the area of the current collector plate portion is smaller than the area of the battery cell. The elastic body portion is arranged outside the outer edge of the current collector plate portion. The clastic body portion overlaps the seal portion.

Here, in the intermediate member disposed in the above-mentioned disposing step, the thickness of the elastic body portion is usually larger than the thickness of the current collector plate portion. In other words, in a state where no load is applied to the intermediate member (current collector plate portion and elastic body portion), the thickness (free length) of the elastic body portion is usually larger than the thickness of the current collector plate portion. If the thickness (free length) of the elastic body portion is larger than the thickness of the current collector plate portion, and a difference in thickness occurs between the electrode lamination portion and the seal portion (the thickness of the electrode lamination portion is larger than the thickness of the seal portion) Even if the elastic body portion is thicker than the seal portion, the elastic body portion can come into contact with the seal portion, and the generation of the above-mentioned gap can be suppressed.

Note that the present disclosure is not limited to the above embodiments. The above embodiments are illustrative, and anything having substantially the same configuration as, and having similar functions and effects to, the technical idea described in the claims of the present disclosure is included in the technical scope of the present disclosure.

What is claimed is:

1. A battery including a laminate, the battery comprising:
a battery cell; and
intermediate members disposed on each of both faces of the battery cell in a thickness direction, wherein:
the battery cell includes an electrode lamination portion in which a plurality of electrodes is laminated in the thickness direction, and a seal portion disposed covering an outer edge of the electrode lamination portion;
the intermediate members include a current collector plate portion and an elastic body portion;
in plan view of the battery from the thickness direction, an area of the current collector plate portion is smaller than an area of the battery cell;
the current collector plate portion includes a notched portion;
the elastic body portion is disposed in the notched portion; and
the elastic body portion overlaps the seal portion.

2. The battery according to claim 1, wherein, with an intermediate member located at a first end of the battery that is a lower side in a gravitational direction, as a first intermediate member, and an intermediate member located at a second end of the battery that is an upper side in the gravitational direction, as a second intermediate member, rigidity of the elastic body portion in the first intermediate member is greater than rigidity of the elastic body portion in the second intermediate member.

3. The battery according to claim 1, wherein the battery includes a plurality of the laminates stacked in the thickness direction.

4. A battery including a laminate, the battery comprising:
a battery cell; and
intermediate members disposed on each of both faces of the battery cell in a thickness direction, wherein:
the battery cell includes an electrode lamination portion in which a plurality of electrodes is laminated in the thickness direction, and a seal portion disposed covering an outer edge of the electrode lamination portion;
the intermediate members include a current collector plate portion and an elastic body portion;
in plan view of the battery from the thickness direction, an area of the current collector plate portion is smaller than an area of the battery cell;
the elastic body portion is disposed outside of an outer edge of the current collector plate portion; and
the elastic body portion overlaps the seal portion.

5. The battery according to claim 4, wherein the elastic body portion is disposed outside an entire periphery of the outer edge of the current collector plate portion.

6. The battery according to claim 4, wherein, with an intermediate member located at a first end of the battery that is a lower side in a gravitational direction, as a first intermediate member, and an intermediate member located at a second end of the battery that is an upper side in the gravitational direction, as a second intermediate member, rigidity of the elastic body portion in the first intermediate member is greater than rigidity of the elastic body portion in the second intermediate member.

7. The battery according to claim 4, wherein the battery includes a plurality of the laminates stacked in the thickness direction.
